(19) United States
(12) Patent Application Publication
(10) Pub. No.: US 2013/0279915 A1
(43) Pub. Date: Oct. 24, 2013

(54) REMOTELY CONTROLLABLE LIGHTING DEVICE

(71) Applicant: LIVINGSTYLE ENTERPRISES LIMITED, Dong Guan City (CN)

(72) Inventors: MING-YUN CHEN, Dong Guan City (CN); SHENG-GUO HONG, Dong Guan City (CN)

(73) Assignee: LivingStyle Enterprises Limited, Dong Guan City (CN)

(21) Appl. No.: 13/864,354

(22) Filed: Apr. 17, 2013

(30) Foreign Application Priority Data
Apr. 20, 2012 (CN) 201220173443.7

(51) Int. Cl. G08C 23/04

(52) U.S. Cl. CPC G08C 23/04
USPC 398/106

(57) ABSTRACT

A remotely controllable lighting device includes a control circuit, a light source, and an infrared receiver. After any remote controller is set as a designated remote controller, the designated remote controller can be used to control the remotely controllable lighting device. Alternatively, after any remote controller performs a controlled mode enabling operation, the remote controller can be used to control the remotely controllable lighting device. After one remote controller directly emits the infrared signal to the infrared receiver and the control circuit simultaneously performs a stipulated learning operation, the remote controller is set as the designated remote controller. Moreover, before the stipulated learning operation is performed, an action of announcing the stipulated learning operation is not done.

### FIELD OF THE INVENTION

The present invention relates to a lighting device, and more particularly to a remotely controllable lighting device.

### BACKGROUND OF THE INVENTION

Nowadays, the indoor power distribution system is implemented by pre-embedding pipelines. That is, during the process of constructing a building, predetermined pipelines are buried at appropriate positions such as walls or ceilings. For example, the pipelines connected to the switches of chandeliers or ceiling lamps on walls have been buried at the predetermined positions during construction or decoration of the building. Since it is difficult to change the positions of the pipelines, the conventional indoor power distribution system is inconvenient to the user. For example, if the bed in a bedroom is far from the switch on a wall, it is troublesome for the user to turn on or turn off the lamp, especially in a chilly winter.

With the development of science and technology, the wired control method is no longer the only choice because a wireless remote control technology goes deeply into every family. For example, various household appliances (e.g. televisions, sound devices, air conditioners or multimedia playback devices) are remotely controllable. Of course, the lighting devices are also remotely controllable.

Conventionally, an infrared remote control technology is one of the most popular wireless remote control technologies applied to the household appliances. Since the infrared signals for the household appliances and the remote controllers that are produced by different manufacturers have different frequencies or identification codes, each household appliance can only be controlled by a corresponding remote controller. As the number of household appliances is increased, the number of remote controllers is correspondingly increased. However, too many remote controllers may confuse the user and make the user unable to realize which remote controller should be used. Consequently, it is a critical issue to provide a method of effectively reducing the number of remote controllers.

For example, an infrared remote control dimmer switch and an infrared remote control switch were disclosed in Chinese utility model patent Nos. CN2475250 and CN2525737, respectively. In these literatures, a control circuit is designed to allow any home-use remote controller to provide the function of turning on/off the lamp or provide the dimming control function.

However, the applications of the control circuit to allow any remote controller to control the lamp are usually restricted, and thus many new problems are generated and need to be solved. For example, when the position of the lamp is very close to a specified one of many household appliances (e.g. an air conditioner), if the remote controller for the specified household appliance (e.g. the air conditioner) is used to control the lamp, the specified household appliance (e.g. the air conditioner) may be erroneously controlled.

For solving the above drawbacks, an intelligent lamp was disclosed in Chinese utility model patent No. CN201731312. By pressing a key module of the intelligent lamp, the intelligent lamp is enabled to perform a stipulated learning operation on the remote control signal of any remote controller for various household appliances. In other words, the remote controller that has been learned by the intelligent lamp can be used to control the intelligent lamp. Consequently, as long as the remote controller for the household appliance close to the intelligent lamp is not subjected to the stipulated learning operation by the intelligent lamp, the possibility of erroneously controlling other household appliances will be minimized.

However, before the stipulated learning operation is performed by the intelligent lamp, the user has to press the key module of the intelligent lamp. That is, before the stipulated learning operation is performed by the intelligent lamp, the stipulated learning operation should be “announced” in advance. The way of announcing the stipulated learning operation in advance is too complicated. In addition, since the intelligent lamp is additionally equipped with the key module for announcing the stipulated learning operation in advance, the fabricating cost of the hardware components is increased.

Therefore, there is a need of providing an improved remotely controllable lighting device in order to overcome the above drawbacks.

### SUMMARY OF THE INVENTION

The present invention provides a remotely controllable lighting device that can be controlled by any remote controller while preventing other electrical appliances from being erroneously controlled.

In accordance with an aspect of the present invention, there is provided a remotely controllable lighting device. The remotely controllable lighting device includes a control circuit, a light source, and an infrared receiver. The control circuit has a frequency reception range that covers a frequency of an infrared signal from at least one remote controller of plural remote controllers. The light source is electrically connected with the control circuit. The infrared receiver is electrically connected with the control circuit for receiving the infrared signal and transmitting the infrared signal to the control circuit. After the at least one remote controller of the plural remote controllers directly emits the infrared signal to the infrared receiver and the control circuit simultaneously performs a stipulated learning operation, the at least one remote controller of the plural remote controllers is set as a designated remote controller for remotely controlling the remotely controllable lighting device. Moreover, before the stipulated learning operation is performed, an action of announcing the stipulated learning operation is not done.

In an embodiment, the stipulated learning operation is performed by operating the at least one remote controller of the plural remote controllers in an emitting mode. In the emitting mode, at least one remote controller of the plural remote controllers is aimed at the infrared receiver to emit the infrared signal.

In an embodiment, the emitting mode is set according to the number of times of the infrared signal is emitted and/or a time duration of emitting the infrared signal.

In an embodiment, whenever the at least one remote controller of the plural remote controllers is aimed at the infrared receiver to emit the infrared signal, the infrared signal has an identical code.

In an embodiment, the control circuit and the designated remote controller communicate with each other according to a control protocol. After the stipulated learning operation is performed, the control circuit and the designated remote controller communicate with each other according to the control protocol, thereby correspondingly controlling the remotely controllable lighting device.

In an embodiment, for establishing the control protocol, the at least one remote controller of the plural remote controllers is operated in an additional emitting mode to issue the infrared signal, and the control circuit judges the additional emitting mode and outputs a corresponding control signal.

In an embodiment, the additional emitting mode is set according to the number of times of the infrared signal is emitted and/or a time duration of emitting the infrared signal.

In an embodiment, the remotely controllable lighting device further includes a switch. The switch is electrically connected between a utility power source and the control circuit. The remotely controllable lighting device is reset according to a switching status of the switch.

In an embodiment, the designated remote controller is operable to turn on/off the remotely controllable lighting device, or control the light source to provide a light beam with a first lighting parameter or a second lighting parameter, or control the remotely controllable lighting device to provide a specified function.

In an embodiment, the first lighting parameter and the second lighting parameter are a first luminance and a second luminance, respectively. Alternatively, the first lighting parameter and the second lighting parameter are a first lighting color temperature and a second lighting color temperature, respectively. Alternatively, the specified function is provided by allowing the remotely controllable lighting device to enter at least one operating mode selected from a human body sensing mode, a burglarproof mode, a power failure lighting mode, an automatic dimming mode, a sleep mode, a holiday mode, an emergency mode, a sound control mode, a song and/or broadcast playback mode, a group control mode, a lighting balance mode, a power-saving mode, a rest mode of resetting the remotely controllable lighting device and a communication device enabling mode.

In an embodiment, the remotely controllable lighting device further comprises at least one of a human body sensor, a backup power source and an optical sensor.

In an embodiment, the human body sensor is a passive infrared human body sensor or a microwave sensor. The backup power source includes at least one of a dry battery, a rechargeable battery, a lithium battery, a solar battery and an external backup power source that provides electric power through a universal serial bus interface. The optical sensor is a photoresistor.

In accordance with another aspect of the present invention, there is provided a remotely controllable lighting device. The remotely controllable lighting device includes a control circuit, a light source, and an infrared receiver. The control circuit has a frequency reception range that covers a frequency of an infrared signal from at least one remote controller of plural remote controllers. The light source is electrically connected with the control circuit. The infrared receiver is electrically connected with the control circuit for receiving the infrared signal and transmitting the infrared signal to the control circuit. During the at least one remote controller of the plural remote controllers directly emits the infrared signal to the infrared receiver and the control circuit performs a stipulated learning operation, the control circuit selects the at least one remote controller of the plural remote controllers as a designated remote controller according to infrared properties of the infrared signal.

In an embodiment, the stipulated learning operation is performed by operating the at least one remote controller of the plural remote controllers in an emitting mode. In the emitting mode, at least one remote controller of the plural remote controllers is aimed at the infrared receiver to emit the infrared signal. The emitting mode is set according to the number of times of the infrared signal is emitted and/or a time duration of emitting the infrared signal.

In accordance with a further aspect of the present invention, there is provided a remotely controllable lighting device. The remotely controllable lighting device includes a control circuit, a light source, and an infrared receiver. The control circuit has a frequency reception range that covers a frequency of an infrared signal from at least one remote controller of plural remote controllers. The light source is electrically connected with the control circuit. The infrared receiver is electrically connected with the control circuit for receiving the infrared signal and transmitting the infrared signal to the control circuit. Before the at least one remote controller of the plural remote controllers is used to control the remotely controllable lighting device, the at least one remote controller is aimed at the infrared receiver to emit the infrared signal and a controlled mode enabling operation is performed. After the controlled mode enabling operation is performed, the control circuit is operated in a controlled mode.

In an embodiment, the controlled mode enabling operation is performed by operating the at least one remote controller of the plural remote controllers in an emitting mode. In the emitting mode, at least one remote controller of the plural remote controllers is aimed at the infrared receiver to emit the infrared signal. The emitting mode is set according to the number of times of the infrared signal is emitted and/or a time duration of emitting the infrared signal.

In an embodiment, the control circuit and the at least one remote controller of the plural remote controllers communicate with each other according to a control protocol. After the controlled mode enabling operation is performed, the control circuit and the at least one remote controller of the plural remote controllers communicate with each other according to the control protocol, thereby correspondingly controlling the remotely controllable lighting device.

In an embodiment, for establishing the control protocol, the at least one remote controller of the plural remote controllers is operated in an additional emitting mode to issue the infrared signal, and the control circuit judges the additional emitting mode and outputs a corresponding control signal. The additional emitting mode is set according to the number of times of the infrared signal is emitted and/or a time duration of emitting the infrared signal.

In an embodiment, the remotely controllable lighting device further includes a switch. The switch is electrically connected between a utility power source and the control circuit. The remotely controllable lighting device is reset according to a switching status of the switch.

In an embodiment, the at least one remote controller of the plural remote controllers is operable to turn on/off the remotely controllable lighting device, control the light source to provide a light beam with a first lighting parameter or a second lighting parameter or control the remotely controllable lighting device to provide a specified function.

Since the structures of the remotely controllable lighting device are specially designed, the remotely controllable lighting device can be controlled by any remote controller while preventing other electrical appliances from being erroneously controlled.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional diagram illustrating a remotely controllable lighting device according to an embodiment of the present invention; and

FIG. 2 schematically illustrates a control protocol applied to the remotely controllable lighting device of FIG. 1.

### DETAILED DESCRIPTION OF THE PREFERRED EMBODIMENT

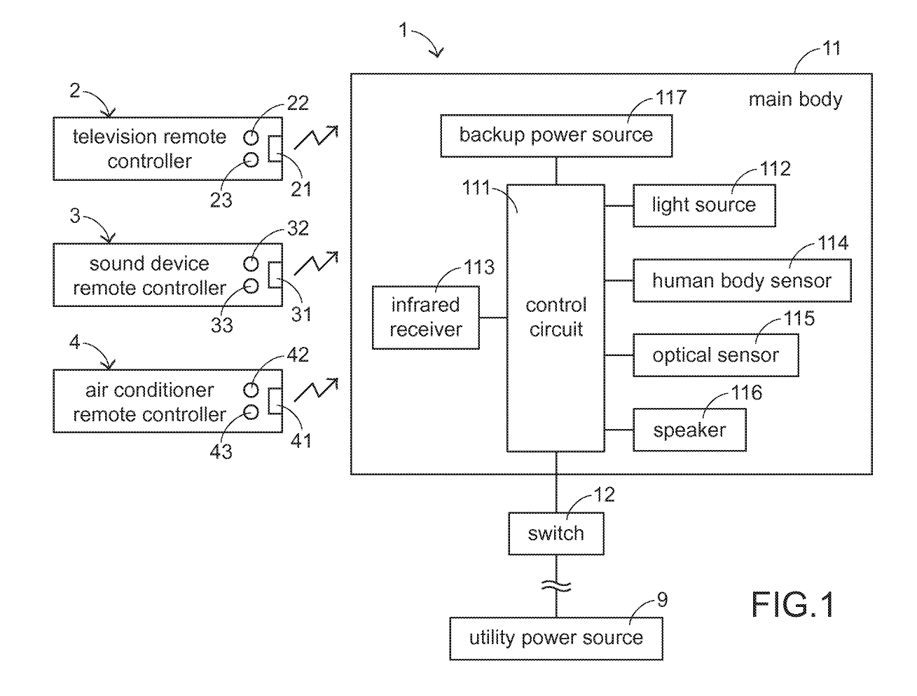

FIG. 1 is a schematic functional diagram illustrating a remotely controllable lighting device according to an embodiment of the present invention. As shown in FIG. 1, the remotely controllable lighting device 1 comprises a main body 11 and a switch 12. The main body 11 comprises a control circuit 111, a light source 112, an infrared receiver 113, a human body sensor 114, an optical sensor 115, a speaker 116, and a backup power source 117. The light source 112, the infrared receiver 113, the human body sensor 114, the optical sensor 115, the speaker 116 and the backup power source 117 are all electrically connected with the control circuit 111. The switch 12 is electrically connected between the control circuit 111 and a utility power source 9. Consequently, when the switch 12 is turned on, the utility power source 9 can provide electric power to the main body 11.

In an embodiment, the human body sensor 114 is a passive infrared human body sensor (PIR) or a microwave sensor. The backup power source 117 includes at least one of a dry battery, a rechargeable battery, a lithium battery, a solar battery and an external backup power source that provides electric power through a universal serial bus (USB) interface. The optical sensor 115 is for example a photoresistor. The examples of the human body sensor 114, the backup power source 117 and the optical sensor 115 are presented herein for purpose of illustration and description only and are not intended to limit the scope of the present invention. Moreover, the human body sensor 114, the optical sensor 115, the speaker 116 and the backup power source 117 are not essential components of the remotely controllable lighting device 1. Moreover, these components are not necessarily installed on the main body 11.

In particular, the infrared receiver 113 of the remotely controllable lighting device 1 is used for receiving infrared signals and transmitting the received infrared signals to the control circuit 111. The control circuit 111 has a wide frequency reception range that covers the frequencies of the infrared signals from plural remote controllers.

Moreover, various remote controllers for controlling different electrical appliances are also schematically shown in FIG. 1. The number and the types of the remote controllers are presented herein for purpose of illustration and description only. As shown in FIG. 1, the plural remote controllers include a television remote controller 2, a sound device remote controller 3, and an air conditioner remote controller 4. The television remote controller 2 comprises a first infrared emitter 21, a first button 22, and a second button 23. When the first button 22 is pressed, the first infrared emitter 21 outputs an infrared signal with a first frequency and a first code. When the second button 23 is pressed, the first infrared emitter 21 outputs an infrared signal with the first frequency and a second code.

Moreover, the sound device remote controller 3 comprises a second infrared emitter 31, a third button 32, and a fourth button 33. When the third button 32 is pressed, the second infrared emitter 31 outputs an infrared signal with a second frequency and a third code. When the fourth button 33 is pressed, the second infrared emitter 31 outputs an infrared signal with the second frequency and a fourth code.

Moreover, the air conditioner remote controller 4 comprises a third infrared emitter 41, a fifth button 42, and a sixth button 43. When the fifth button 42 is pressed, the third infrared emitter 41 outputs an infrared signal with a third frequency and a fifth code. When the sixth button 43 is pressed, the third infrared emitter 41 outputs an infrared signal with the third frequency and a sixth code.

Two methods of implementing the remotely controllable lighting device 1 of the present invention will be illustrated in more details as follows. Consequently, when the remotely controllable lighting device 1 is remotely controlled by a specified remote controller of plural remote controllers, other electrical appliances close to the remotely controllable lighting device 1 will not be erroneously controlled. For example, if the infrared receiver 113 of the remotely controllable lighting device 1 as shown in FIG. 1 is close to a television, when the television remote controller 2 is used to control the remotely controllable lighting device 1, the television will not be erroneously controlled. Moreover, if the infrared receiver 113 of the remotely controllable lighting device 1 is close to a sound device, when the sound device remote controller 3 is used to control the remotely controllable lighting device 1, the sound device will not be erroneously controlled. Moreover, if the infrared receiver 113 of the remotely controllable lighting device 1 is close to an air conditioner, when the air conditioner remote controller 4 is used to control the remotely controllable lighting device 1, the air conditioner will not be erroneously controlled.

In accordance with a first implementing method, at least one remote controller of plural remote controllers (preferably excluding the remote controllers for the electrical appliances close to the infrared receiver 113 of the remotely controllable lighting device 1) is set as a designated remote controller for controlling the remotely controllable lighting device 1. In particular, after the at least one remote controller of the plural remote controllers directly emits any infrared signal to the infrared receiver 113 and the control circuit 111 simultaneously performs a stipulated learning operation, the at least one remote controller is set as the designated remote controller for controlling the remotely controllable lighting device 1.

During the stipulated learning operation is performed by the control circuit 111, the control circuit 111 may select the at least one remote controller of the plural remote controllers as the designated remote controller according to the infrared properties of the infrared signal. More especially, before the stipulated learning operation is performed, it is not necessary to announce the stipulated learning operation in advance. The way of announcing the stipulated learning operation in advance has been mentioned in the background of the present invention, and is not redundantly described herein.

Moreover, the stipulated learning operation is performed by operating the at least one remote controller of the plural remote controllers in an emitting mode. In the emitting mode, the at least one remote controller of the plural remote controllers is aimed at the infrared receiver 113 to emit an infrared signal. The conditions of the emitting mode may be set by the manufacturer or the user according to the practical requirements. For example, the conditions of the emitting mode may be set by the manufacturer or the user according to the number of times of the infrared signal is emitted or the time duration of emitting the infrared signal.

In an embodiment, the emitting mode is set according to the number of times of the infrared signal is emitted. That is, after any remote controller is aimed at the infrared receiver 113 to emit the infrared signal for a specified number of times, the stipulated learning operation is completed by the control circuit 111.

For example, it is assumed that the specified number of times is set as three times by the manufacturer. When the television remote controller 2 is aimed at the infrared receiver 113, if the first button 22 is successively pressed for three times or the second button 23 is successively pressed for three times or any of the first button 22 and the second button 23 is successively pressed for three times (for example the first button 22, the second button 23 and the second button 23 are sequentially pressed), the infrared signal with the first frequency is successively received by the infrared receiver 113 for three times. Since the frequency (i.e. the first frequency) of the received infrared signal is identified by the control circuit 111, the stipulated learning operation is completed by the control circuit 111. From now on, the television remote controller 2 may be used to control the remotely controllable lighting device 1.

Moreover, for example, it is assumed that the specified number of times is set as four by the manufacturer. When the sound device remote controller 3 is aimed at the infrared receiver 113, if the third button 32 is successively pressed for four times or the fourth button 33 is successively pressed for four times or any of the third button 32 and the fourth button 33 is successively pressed for four times (for example the fourth button 33, the third button 32, the third button 32 and the fourth button 33 are sequentially pressed), the infrared signal with the second frequency is successively received by the infrared receiver 113 for four times. Since the frequency (i.e. the second frequency) of the received infrared signal is identified by the control circuit 111, the stipulated learning operation is completed by the control circuit 111. From now on, the sound device remote controller 3 may be used to control the remotely controllable lighting device 1.

Moreover, for example, it is assumed that the specified number of times is set as three times by the manufacturer. When the air conditioner remote controller 4 is aimed at the infrared receiver 113, if the fifth button 42 is successively pressed for three times or the sixth button 43 is successively pressed for three times or any of the fifth button 42 and the sixth button 43 is successively pressed for three times (for example the sixth button 43, the sixth button 43 and the fifth button 42 are sequentially pressed), the infrared signal with the third frequency is successively received by the infrared receiver 113 for three times. Since the frequency (i.e. the third frequency) of the received infrared signal is identified by the control circuit 111, the stipulated learning operation is completed by the control circuit 111. From now on, the air conditioner remote controller 4 may be used to control the remotely controllable lighting device 1.

However, those skilled in the art will readily observe that numerous modifications and alterations may be made while retaining the teachings of the above three examples.

In another embodiment, the emitting mode is set according to the number of times of the infrared signal is emitted and the time duration of emitting the infrared signal. For performing the stipulated learning operation, in at least one time of the specified number of times, the remote controller should be continuously aimed at the infrared receiver 113 to emit the infrared signal for a specified time duration.

For example, it is assumed that the specified number of times is set as one and the specified time duration is set as three seconds by the manufacturer. When the television remote controller 2 is aimed at the infrared receiver 113, if the first button 22 is continuously pressed for three seconds or the second button 23 is continuously pressed for three seconds, the infrared signal with the first frequency is continuously received by the infrared receiver 113 for three seconds. Since the frequency (i.e. the first frequency) of the received infrared signal is identified by the control circuit 111, the stipulated learning operation is completed by the control circuit 111. From now on, the television remote controller 2 may be used to control the remotely controllable lighting device 1.

Moreover, for example, it is assumed that the specified number of times is set as two and the specified time duration is set as five seconds by the manufacturer. When the sound device remote controller 3 is aimed at the infrared receiver 113, if the third button 32 is continuously pressed for five seconds and then the fourth button 33 is pressed or if the fourth button 33 is continuously pressed for five seconds and then the third button 32 is pressed, the infrared signal with the second frequency is successively received by the infrared receiver 113 for two times and the infrared signal is continuously received for five seconds at the first time. Since the frequency (i.e. the second frequency) of the received infrared signal is identified by the control circuit 111, the stipulated learning operation is completed by the control circuit 111. From now on, the sound device remote controller 3 may be used to control the remotely controllable lighting device 1.

However, those skilled in the art will readily observe that numerous modifications and alterations may be made while retaining the teachings of the above two examples.

In another embodiment, the conditions for performing the stipulated learning operation may be further restricted. For example, whenever the remote controller is aimed at the infrared receiver 113 to emit the infrared signal, the infrared signal should have the identical code. That is, when the same button of the same remote controller is successively pressed by the user for a specified number of times and at least one time of pressing this button is continued for a specified time duration, the stipulated learning operation is completed by the control circuit 111.

A second implementing method will be illustrated as follows. Before at least one remote controller of plural remote controllers (preferably excluding the remote controllers for the electrical appliances close to the infrared receiver 113 of the remotely controllable lighting device 1) is used for controlling the remotely controllable lighting device 1, the at least one remote controller is aimed at the infrared receiver 113 to emit any infrared signal and a controlled mode enabling operation is performed. After the controlled mode enabling operation is performed, the control circuit 111 is operated in a controlled mode, and thus the at least one remote controller is capable of controlling the remotely controllable lighting device 1. In comparison with the first method, the second method does not need to perform the stipulated learning operation by setting the at least one remote controller of the plural remote controllers as the designated remote controller.

Moreover, the controlled mode enabling operation is performed by operating the at least one remote controller of the plural remote controllers in an emitting mode. In the emitting mode, the at least one remote controller of the plural remote controllers is aimed at the infrared receiver 113 to emit an infrared signal. The conditions of the emitting mode may be set by the manufacturer or the user according to the practical requirements. For example, the conditions of the emitting mode may be set by the manufacturer or the user according to the number of times of the infrared signal is emitted or the time duration of emitting the infrared signal.

In an embodiment, the emitting mode is set according to the number of times of the infrared signal is emitted. That is, after any remote controller is aimed at the infrared receiver 113 to emit the infrared signal for a specified number of times, the controlled mode enabling operation is completed by the control circuit 111. Consequently, the control circuit 111 is operated in the controlled mode.

For example, it is assumed that the specified number of times is set as three times by the manufacturer. When the television remote controller 2 is aimed at the infrared receiver 113, if the first button 22 is successively pressed for three times or the second button 23 is successively pressed for three times or any of the first button 22 and the second button 23 is successively pressed for three times (for example the first button 22, the second button 23 and the second button 23 are sequentially pressed), the infrared signal with the first frequency is successively received by the infrared receiver 113 for three times. Since the frequency (i.e. the first frequency) of the received infrared signal is identified by the control circuit 111, the control circuit 111 is operated in the controlled mode. From now on, the television remote controller 2 may be used to control the remotely controllable lighting device 1.

Moreover, for example, it is assumed that the specified number of times is set as four times by the manufacturer. When the sound device remote controller 3 is aimed at the infrared receiver 113, if the third button 32 is successively pressed for four times or the fourth button 33 is successively pressed for four times or any of the third button 32 and the fourth button 33 is successively pressed for four times (for example the fourth button 33, the third button 32, the third button 32 and the fourth button 33 are sequentially pressed), the infrared signal with the second frequency is successively received by the infrared receiver 113 for four times. Since the frequency (i.e. the second frequency) of the received infrared signal is identified by the control circuit 111, the control circuit 111 is operated in the controlled mode. From now on, the sound device remote controller 3 may be used to control the remotely controllable lighting device 1.

Moreover, for example, it is assumed that the specified number of times is set as three times by the manufacturer. When the air conditioner remote controller 4 is aimed at the infrared receiver 113, if the fifth button 42 is successively pressed for three times or the sixth button 43 is successively pressed for three times or any of the fifth button 42 and the sixth button 43 is successively pressed for three times (for example the sixth button 43, the sixth button 43 and the fifth button 42 are sequentially pressed), the infrared signal with the third frequency is successively received by the infrared receiver 113 for three times. Since the frequency (i.e. the third frequency) of the received infrared signal is identified by the control circuit 111, the control circuit 111 is operated in the controlled mode. From now on, the air conditioner remote controller 4 may be used to control the remotely controllable lighting device 1.

However, those skilled in the art will readily observe that numerous modifications and alterations may be made while retaining the teachings of the above three examples.

In another embodiment, the emitting mode is set according to the number of times of the infrared signal is emitted and the time duration of emitting the infrared signal. For performing the controlled mode enabling operation, in at least one time of the specified number of times, the remote controller should be continuously aimed at the infrared receiver 113 to emit the infrared signal for a specified time duration.

For example, it is assumed that the specified number of times is set as one and the specified time duration is set as three seconds by the manufacturer. When the television remote controller 2 is aimed at the infrared receiver 113, if the first button 22 is continuously pressed for three seconds or the second button 23 is continuously pressed for three seconds, the infrared signal with the first frequency is continuously received by the infrared receiver 113 for three seconds. Since the frequency (i.e. the first frequency) of the received infrared signal is identified by the control circuit 111, the control circuit 111 is operated in the controlled mode. From now on, the television remote controller 2 may be used to control the remotely controllable lighting device 1.

Moreover, for example, it is assumed that the specified number of times is set as two times and the specified time duration is set as five seconds by the manufacturer. When the sound device remote controller 3 is aimed at the infrared receiver 113, if the third button 32 is continuously pressed for five seconds and then the fourth button 33 is pressed or if the fourth button 33 is continuously pressed for five seconds and then the third button 32 is pressed, the infrared signal with the second frequency is successively received by the infrared receiver 113 for two times and the infrared signal is continuously received for five seconds at the first time. Since the frequency (i.e. the second frequency) of the received infrared signal is identified by the control circuit 111, the control circuit 111 is operated in the controlled mode. From now on, the sound device remote controller 3 may be used to control the remotely controllable lighting device 1.

However, those skilled in the art will readily observe that numerous modifications and alterations may be made while retaining the teachings of the above two examples.

In another embodiment, the conditions for performing the controlled mode enabling operation may be further restricted. For example, whenever the remote controller is aimed at the infrared receiver 113 to emit the infrared signal, the infrared signal should have the identical code. That is, when the same button of the same remote controller is successively pressed by the user for a specified number of times and at least one time of pressing this button is continued for a specified time duration, the control circuit 111 is operated in the controlled mode.

From the above discussions, after any remote controller is set as the designated remote controller, the designated remote controller can be used to control any action of the remotely controllable lighting device 1. Alternatively, after any remote controller is aimed at the infrared receiver 113 to perform a controlled mode enabling operation, the remote controller can be used to control any action of the remotely controllable lighting device 1.

More especially, the control circuit 111 and any remote controller can communicate with each other according to a control protocol. In addition, after any remote controller is set as the designated remote controller or after any remote controller is aimed at the infrared receiver 113 to perform the controlled mode enabling operation, the control circuit 111 and the remote controller communicate with each other according to the control protocol in order to control a corresponding action of the remotely controllable lighting device 1.

Moreover, for establishing the control protocol, the at least one remote controller of the plural remote controllers is operated in an additional emitting mode to issue an infrared signal, and the control circuit 111 judges the additional emitting mode and outputs a corresponding control signal. The conditions of the additional emitting mode may be set by the manufacturer or the user according to the practical requirements. For example, the conditions of the additional emitting mode may be set by the manufacturer or the user according to the number of times of the infrared signal is emitted or the time duration of emitting the infrared signal. The way of setting the additional emitting mode is similar to that of the way of setting the emitting mode. However, those skilled in the art will readily observe that numerous modifications and alterations of setting the additional emitting mode may be made while retaining the above teachings.

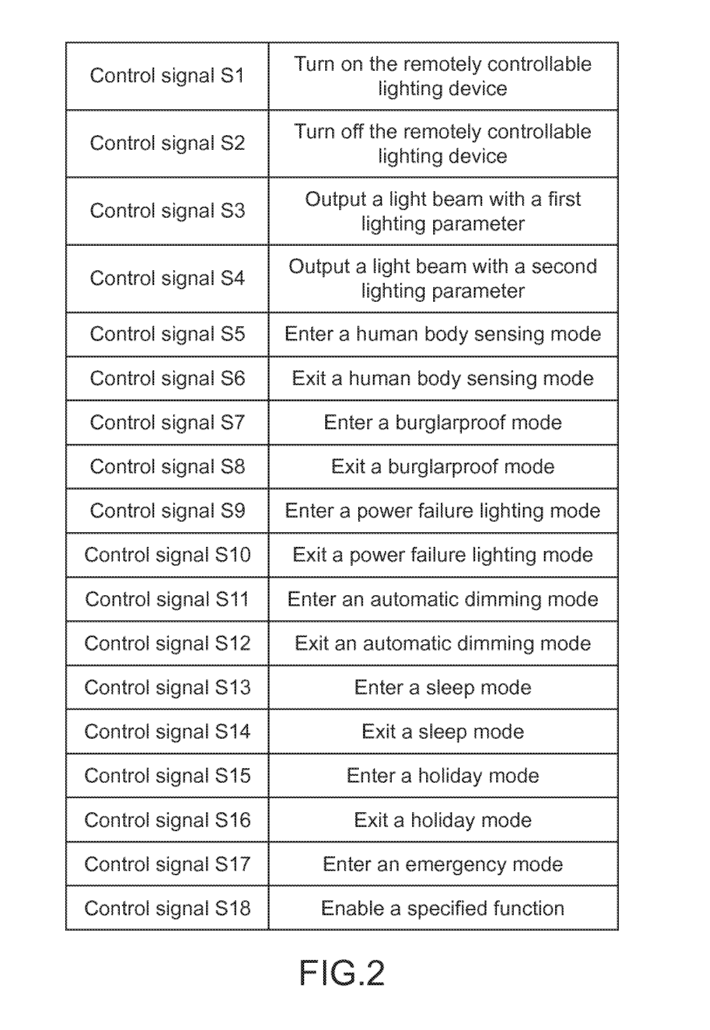

FIG. 2 schematically illustrates a control protocol applied to the remotely controllable lighting device of FIG. 1.

In response to a control signal S1 from the control circuit 111, the remotely controllable lighting device 1 is turned on. Consequently, the light source 112 is enabled to output a light beam. In response to a control signal S2 from the control circuit 111, the remotely controllable lighting device 1 is turned off. Consequently, the light source 112 stops outputting the light beam.

In response to a control signal S3 from the control circuit 111, the light source 112 is driven to output a light beam with a first lighting parameter. In response to a control signal S4 from the control circuit 111, the light source 112 is driven to output a light beam with a second lighting parameter. In an embodiment, the first lighting parameter and the second lighting parameter are a first luminance and a second luminance, respectively. Alternatively, the first lighting parameter and the second lighting parameter are a first lighting color temperature and a second lighting color temperature, respectively. The examples of the first lighting parameter and the second lighting parameter are presented herein for purpose of illustration and description only and are not intended to limit the scope of the present invention.

In response to a control signal S5 from the control circuit 111, the remotely controllable lighting device 1 enters a human body sensing mode. In particular, the human body sensor 114 is used for detecting whether there is a human body within a detecting range. When the human body sensing mode of the remotely controllable lighting device 1 is enabled, if the human body sensor 114 detects that there is a human body within the detecting range, the human body sensor 114 issues a human body sensing signal to the control circuit 111. In response to the human body sensing signal, the light source 112 is driven to provide a light beam. In response to a control signal S6 from the control circuit 111, the remotely controllable lighting device 1 exits the human body sensing mode.

In response to a control signal S7 from the control circuit 111, the remotely controllable lighting device 1 enters a burglarproof mode. In particular, when the remotely controllable lighting device 1 enters the burglarproof mode, if the human body sensor 114 detects that there is a human body within the detecting range, the human body sensor 114 issues a human body sensing signal to the control circuit 111. In response to the human body sensing signal, the light source 112 is driven to continuously output a light beam or intermittently output the light beam in order to provide a burglarproof prompt, or the speaker 116 is driven to continuously output a sound or intermittently output the sound in order to provide a burglarproof prompt. In response to a control signal S8 from the control circuit 111, the remotely controllable lighting device 1 exits the burglarproof mode.

In response to a control signal S9 from the control circuit 111, the remotely controllable lighting device 1 enters a power failure lighting mode. In particular, when the remotely controllable lighting device 1 enters the power failure lighting mode, if the utility power source 9 fails to provide electric power to the remotely controllable lighting device 1, the control circuit 111 will drive the backup power source 117 to provide backup electric power. Consequently, the light source provides an emergency light beam. In response to a control signal S10 from the control circuit 111, the remotely controllable lighting device 1 exits the power failure lighting mode.

In response to a control signal S11 from the control circuit 111, the remotely controllable lighting device 1 enters an automatic dimming mode. In particular, when the remotely controllable lighting device 1 enters the automatic dimming mode, the optical sensor 115 starts to detect the ambient brightness of the remotely controllable lighting device 1, thereby issuing a brightness sensing signal to the control circuit 111. In response to the brightness sensing signal, the light source 112 is driven to provide a corresponding light beam. For example, if the ambient brightness detected by the optical sensor 115 is too low, the control circuit 111 will drive the light source 112 to provide a brighter light beam. On the other hand, if the ambient brightness detected by the optical sensor 115 is too high, the control circuit 111 will drive the light source 112 to provide a darker light beam. In response to a control signal S12 from the control circuit 111, the remotely controllable lighting device 1 exits the automatic dimming mode.

In response to a control signal S13 from the control circuit 111, the remotely controllable lighting device 1 enters a sleep mode. In particular, when the remotely controllable lighting device 1 enters the sleep mode, the control circuit 111 will drive the light source 112 to provide a light beam. The brightness of the light beam is gradually reduced within a certain time period until the light source is completely turned off. In response to a control signal S14 from the control circuit 111, the remotely controllable lighting device 1 exits the sleep mode.

In response to a control signal S15 from the control circuit 111, the remotely controllable lighting device 1 enters a holiday mode. In particular, when the remotely controllable lighting device 1 enters the holiday mode, the control circuit 111 will drive the light source 112 to continuously output a light beam or intermittently output the light beam for a certain time period at a specified time spot or an unspecified time spot in order to pretend that there is someone in the room. Consequently, when the user goes out for a long term, the possibility of having the thief break into the house will be minimized. In response to a control signal S16 from the control circuit 111, the remotely controllable lighting device 1 exits the holiday mode.

In response to a control signal S17 from the control circuit 111, the remotely controllable lighting device 1 enters an emergency mode. In particular, when the remotely controllable lighting device 1 enters the emergency mode, the control circuit 111 will drive the light source 112 to continuously output a light beam or intermittently output the light beam, or the control circuit 111 will drive the speaker 116 to continuously output a sound or intermittently output the sound. Alternatively, in the emergency mode, the remotely controllable lighting device 1 or other device will be driven to provide any noticeable message. Consequently, in the event of a dangerous or emergency situation, the user can get help quickly.

Moreover, according to the practical requirements, the control protocol may be set by the manufacturer or the user. For example, in response to control signal S18 from the control circuit 111, a specified function of the remotely controllable lighting device 1 is enabled. For example, after the specified function is enabled, the remotely controllable lighting device 1 enters a sound control mode, a song and/or broadcast playback mode, a group control mode, a lighting balance mode, a power-saving mode, a rest mode of resetting the remotely controllable lighting device 1, or a communication device enabling mode.

Moreover, the remotely controllable lighting device 1 can be reset according to a switching status of the switch 12. For example, when the switch 12 is changed from an on state to an off state, the remotely controllable lighting device 1 is reset, and thus the remotely controllable lighting device 1 exits the original working mode.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A remotely controllable lighting device, comprising:
a control circuit having a frequency reception range that covers a frequency of an infrared signal from at least one remote controller of plural remote controllers;
a light source electrically connected with said control circuit; and
an infrared receiver electrically connected with said control circuit for receiving said infrared signal and transmitting said infrared signal to said control circuit,
wherein after said at least one remote controller of said plural remote controllers directly emits said infrared signal to said infrared receiver and said control circuit simultaneously performs a stipulated learning operation, said at least one remote controller of said plural remote controllers is set as a designated remote controller for remotely controlling said remotely controllable lighting device, wherein before said stipulated learning operation is performed, an action of announcing said stipulated learning operation is not done.

2. The remotely controllable lighting device according to claim 1, wherein said stipulated learning operation is performed by operating said at least one remote controller of said plural remote controllers in an emitting mode, wherein in said emitting mode, at least one remote controller of said plural remote controllers is aimed at said infrared receiver to emit said infrared signal.

3. The remotely controllable lighting device according to claim 2, wherein said emitting mode is set according to the number of times of said infrared signal is emitted and/or a time duration of emitting said infrared signal.

4. The remotely controllable lighting device according to claim 2, wherein whenever said at least one remote controller of said plural remote controllers is aimed at said infrared receiver to emit said infrared signal, said infrared signal has an identical code.

5. The remotely controllable lighting device according to claim 1, wherein said control circuit and said designated remote controller communicate with each other according to a control protocol, wherein after said stipulated learning operation is performed, said control circuit and said designated remote controller communicate with each other according to said control protocol, thereby correspondingly controlling said remotely controllable lighting device.

6. The remotely controllable lighting device according to claim 5, wherein for establishing said control protocol, said at least one remote controller of said plural remote controllers is operated in an additional emitting mode to issue said infrared signal, and said control circuit judges said additional emitting mode and outputs a corresponding control signal.

7. The remotely controllable lighting device according to claim 6, wherein said additional emitting mode is set according to the number of times of said infrared signal is emitted and/or a time duration of emitting said infrared signal.

8. The remotely controllable lighting device according to claim 5, further comprising a switch, wherein said switch is electrically connected between a utility power source and said control circuit, wherein said remotely controllable lighting device is reset according to a switching status of said switch.

9. The remotely controllable lighting device according to claim 1, wherein said designated remote controller is operable to turn on/off said remotely controllable lighting device, or control said light source to provide a light beam with a first lighting parameter or a second lighting parameter, or control said remotely controllable lighting device to provide a specified function.

10. The remotely controllable lighting device according to claim 9, wherein said first lighting parameter and said second lighting parameter are a first luminance and a second luminance, respectively; or said first lighting parameter and said second lighting parameter are a first lighting color temperature and a second lighting color temperature, respectively; or said specified function is provided by allowing said remotely controllable lighting device to enter at least one operating mode selected from a human body sensing mode, a burglarproof mode, a power failure lighting mode, an automatic dimming mode, a sleep mode, a holiday mode, an emergency mode, a sound control mode, a song and/or broadcast playback mode, a group control mode, a lighting balance mode, a power-saving mode, a rest mode of resetting said remotely controllable lighting device and a communication device enabling mode.

11. The remotely controllable lighting device according to claim 1, wherein said remotely controllable lighting device further comprises at least one of a human body sensor, a backup power source and an optical sensor.

12. The remotely controllable lighting device according to claim 11, wherein said human body sensor is a passive infrared human body sensor or a microwave sensor; or said backup power source includes at least one of a dry battery, a rechargeable battery, a lithium battery, a solar battery and an external backup power source that provides electric power through a universal serial bus interface; or said optical sensor is a photoresistor.

13. A remotely controllable lighting device, comprising:
a control circuit having a frequency reception range that covers a frequency of an infrared signal from at least one remote controller of plural remote controllers;
a light source electrically connected with said control circuit; and
an infrared receiver electrically connected with said control circuit for receiving said infrared signal and transmitting said infrared signal to said control circuit,
wherein during said at least one remote controller of said plural remote controllers directly emits said infrared signal to said infrared receiver and said control circuit performs a stipulated learning operation, said control circuit selects said at least one remote controller of said plural remote controllers as a designated remote controller according to infrared properties of said infrared signal.

14. The remotely controllable lighting device according to claim 13, wherein said stipulated learning operation is performed by operating said at least one remote controller of said plural remote controllers in an emitting mode, wherein in said emitting mode, at least one remote controller of said plural remote controllers is aimed at said infrared receiver to emit said infrared signal, wherein said emitting mode is set according to the number of times of said infrared signal is emitted and/or a time duration of emitting said infrared signal.

15. A remotely controllable lighting device, comprising:
a control circuit having a frequency reception range that covers a frequency of an infrared signal from at least one remote controller of plural remote controllers;
a light source electrically connected with said control circuit; and
an infrared receiver electrically connected with said control circuit for receiving said infrared signal and transmitting said infrared signal to said control circuit,
wherein before said at least one remote controller of said plural remote controllers is used to control said remotely controllable lighting device, said at least one remote controller is aimed at said infrared receiver to emit said infrared signal and a controlled mode enabling operation is performed, wherein after said controlled mode enabling operation is performed, said control circuit is operated in a controlled mode.

16. The remotely controllable lighting device according to claim 15, wherein said controlled mode enabling operation is performed by operating said at least one remote controller of said plural remote controllers in an emitting mode, wherein in said emitting mode, at least one remote controller of said plural remote controllers is aimed at said infrared receiver to emit said infrared signal, wherein said emitting mode is set according to the number of times of said infrared signal is emitted and/or a time duration of emitting said infrared signal.

17. The remotely controllable lighting device according to claim 15, wherein said control circuit and said at least one remote controller of said plural remote controllers communicate with each other according to a control protocol, wherein after said controlled mode enabling operation is performed, said control circuit and said at least one remote controller of said plural remote controllers communicate with each other according to said control protocol, thereby correspondingly controlling said remotely controllable lighting device.

18. The remotely controllable lighting device according to claim 17, wherein for establishing said control protocol, said at least one remote controller of said plural remote controllers is operated in an additional emitting mode to issue said infrared signal, and said control circuit judges said additional emitting mode and outputs a corresponding control signal, wherein said additional emitting mode is set according to the number of times said infrared signal is emitted and/or a time duration of emitting said infrared signal.

19. The remotely controllable lighting device according to claim 17, further comprising a switch, wherein said switch is electrically connected between a utility power source and said control circuit, wherein said remotely controllable lighting device is reset according to a switching status of said switch.

20. The remotely controllable lighting device according to claim 15, wherein said at least one remote controller of said plural remote controllers is operable to turn on/off said remotely controllable lighting device, control said light source to provide a light beam with a first lighting parameter or a second lighting parameter or control said remotely controllable lighting device to provide a specified function.
